(19) United States
(12) Patent Application Publication
(10) Pub. No.: US 2019/0086968 A1
(43) Pub. Date: Mar. 21, 2019

(54) MOBILE TERMINAL

(71) Applicant: LG ELECTRONICS INC., Seoul (KR)

(72) Inventors: Changwon YUN, Seoul (KR); Changil KIM, Seoul (KR); Hanphil RHYU, Seoul (KR); Sungjung RHO, Seoul (KR); Chisang YOU, Seoul (KR)

(73) Assignee: LG ELECTRONICS INC., Seoul (KR)

(21) Appl. No.: 15/955,578

(22) Filed: Apr. 17, 2018

Related U.S. Application Data
(60) Provisional application No. 62/559,637, filed on Sep. 18, 2017.

(30) Foreign Application Priority Data
Jan. 5, 2018 (KR) 10-2018-0001515

(51) Int. Cl. G06F 1/16; H01Q 1/22; H01Q 1/38; G06K 19/077

(52) U.S. Cl. CPC G06F 1/1656; H01Q 1/2266; H01Q 1/2216; G06K 19/07749; H01Q 1/38

(57) ABSTRACT

Disclosed is a mobile terminal including a main body including a rear case including a metal part, an opening formed through the rear case, a coil antenna located within the main body and including a plurality of conductive strips, and a feeder configured to apply power to the coil antenna. The coil antenna includes first conductive strips extending in a first direction, at least some of the first conductive strips overlapping the opening, second conductive strips located at one side of the first conductive strips in a second direction perpendicular to the first direction and connected to the first conductive strips to form a first loop, and third conductive strips located at the other side of the first conductive strips in the second direction and connected to the first conductive strips to form a second loop, and the first to third conductive strips are connected to form a continuous coil.

### CROSS-REFERENCE TO RELATED APPLICATIONS

Pursuant to 35 U.S.C. § 119, this application claims the benefit of U.S. Provisional Application No. 62/559,637, filed on Sep. 18, 2017 and also claims the benefit of earlier filing date and right of priority to Korean Patent Application No. 10-2018-0001515, filed on Jan. 5, 2018, the contents of which are all incorporated by reference herein in their entirety.

### BACKGROUND OF THE INVENTION

### Field of the Invention

The present invention relates to a mobile terminal having a metal case which improves wireless communication performance.

### Discussion of the Related Art

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As such functions become more diversified, the mobile terminal can support more complicated functions such as capturing images or video, reproducing music or video files, playing games, receiving broadcast signals, and the like. By comprehensively and collectively implementing such functions, the mobile terminal may be embodied in the form of a multimedia player or device.

Further, mobile terminals may transmit and receive information using wireless communication with external apparatuses and thus functions of the mobile terminals may be extended. For example, data transmission between mobile terminals and specific functions of the mobile terminals may be performed. Further, payment using mobile terminals is possible. Moreover, as usages of mobile terminals are diversified, the quantity of a battery consumed is increased and demand for a wireless charging function in which the battery is charged only by being located close to a wireless charger without use of a separate cable so as to be easily charged is increased now.

Simple exterior design is preferred and thus materials, such as a metal, etc., are in the spotlight. However, if a metal is used, quality of inner parts, particularly, a wireless communication function or a wireless charging function, may be degraded.

### SUMMARY OF THE INVENTION

Accordingly, the present invention is directed to a mobile terminal that substantially obviates one or more problems due to limitations and disadvantages of the related art.

An object of the present invention is to provide a mobile terminal having a metal case which improves wireless communication performance.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a mobile terminal includes a main body including a rear case including a metal part, an opening formed through the rear case, a coil antenna located within the main body and including a plurality of conductive strips, and a feeder configured to apply power to the coil antenna, wherein the coil antenna includes first conductive strips extending in a first direction, at least some of the first conductive strips overlapping the opening, second conductive strips located at one side of the first conductive strips in a second direction perpendicular to the first direction and connected to the first conductive strips to form a first loop, and third conductive strips located at the other side of the first conductive strips in the second direction and connected to the first conductive strips to form a second loop, wherein the first conductive strips, the second conductive strips and the third conductive strips are connected to form a continuous coil.

By power applied by the feeder, current may flow along the first conductive strips in the first direction, flow along the second conductive strips in the clockwise direction and flow along the third conductive strips in the counterclockwise direction.

A width of the opening in the second direction may be greater than a width of an area, where the first conductive strips are formed, in the second direction.

The coil antenna may further include an insulating substrate provided with one surface and the other surface, on which the conductive strips are divisionally arranged, and via holes formed through the insulating substrate and connecting the conductive strips formed on both surfaces of the insulating substrate.

The first conductive strips may be divisionally arranged on both surfaces of the insulating substrate so as to overlap each other.

The insulating substrate may include open areas formed in regions surrounded by the first loop and the second loop.

The first conductive strips, the second conductive strips and the third conductive strips may be provided in plural, and the number of the first conductive strips may be the sum of the number of the second conductive strips and the number of the third conductive strips.

One end of each of the first conductive strips may be connected to the second conductive strip and the other end of each of the first conductive strips may be connected to the third conductive strip so that the first conductive strips, the second conductive strips and the third conductive strips are connected in an 8 shape.

The first conductive strips may include a first group of first conductive strips provided with both ends connected to the second conductive strips to form a spiral-shaped first loop, and a second group of first conductive strips provided with both ends connected to the third conductive strips to form a spiral-shaped second loop.

The opening may be located at the center of the rear case.

The opening may be surrounded by the metal part of the rear case.

The mobile terminal may further include one of a rear button and a camera arranged on a rear surface of the main body and exposed from the rear surface through the opening.

The coil antenna may be attached to an inner surface of the rear case.

The mobile terminal may further include a controller configured to control the feeder so as to perform NFC wireless communication through the coil antenna.

In another aspect of the present invention, a mobile terminal includes a main body including a rear case including a metal, an opening formed through the rear case, a pair of cameras exposed from a rear surface of the main body through the opening, a coil antenna located within the main body and including a plurality of conductive strips, and a feeder configured to apply power to the coil antenna, wherein the coil antenna includes first conductive strips extending in a first direction and located between the pair of cameras, at least some of the first conductive strips overlapping the opening, second conductive strips located at one side of the first conductive strips in a second direction perpendicular to the first direction and formed in a C shape, and third conductive strips located at the other side of the first conductive strips in the second direction and formed in a C shape, wherein the first conductive strips, the second conductive strips and the third conductive strips are connected to form one 8-shaped coil.

The coil antenna may further include an insulating substrate provided with one surface and the other surface, on which the conductive strips are divisionally arranged, and via holes formed through the insulating substrate and connecting the conductive strips formed on both surfaces of the insulating substrate, and the insulating substrate may include open areas formed in regions surrounded by the first loop and the second loop, the pair of cameras being located in the open areas.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1A is a block diagram of a mobile terminal in accordance with the present invention;

FIGS. 1B and 1C are conceptual views of one example of the mobile terminal in accordance with the present invention, viewed from different directions;

FIG. 2 is a view illustrating a coil antenna of the mobile terminal in accordance with the present invention;

FIG. 3 is a view illustrating the coil antenna attached to an inner surface of a rear case of the mobile terminal in accordance with the present invention;

FIG. 4 and FIG. 5 are views illustrating electric fields (E-fields) and magnetic fields (H-fields) formed in the coil antenna and on the rear case of the mobile terminal in accordance with the present invention;

FIG. 6 is a view illustrating a magnetic field formed on the mobile terminal in accordance with the present invention;

FIG. 7 is a view illustrating coil antennas of the mobile terminal in accordance with other embodiments of the present invention;

FIG. 8 is a view illustrating arrangements of the coil antenna and an opening of the mobile terminal in accordance with the present invention; and

FIG. 9 is a view illustrating arrangement of the coil antenna and cameras of the mobile terminal in accordance with the present invention.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

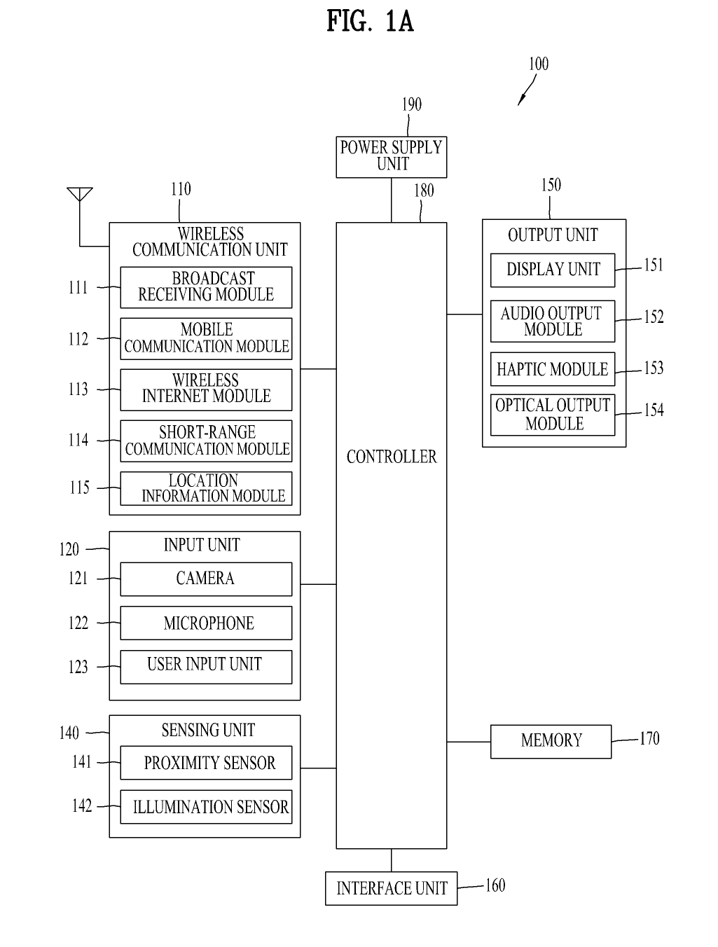

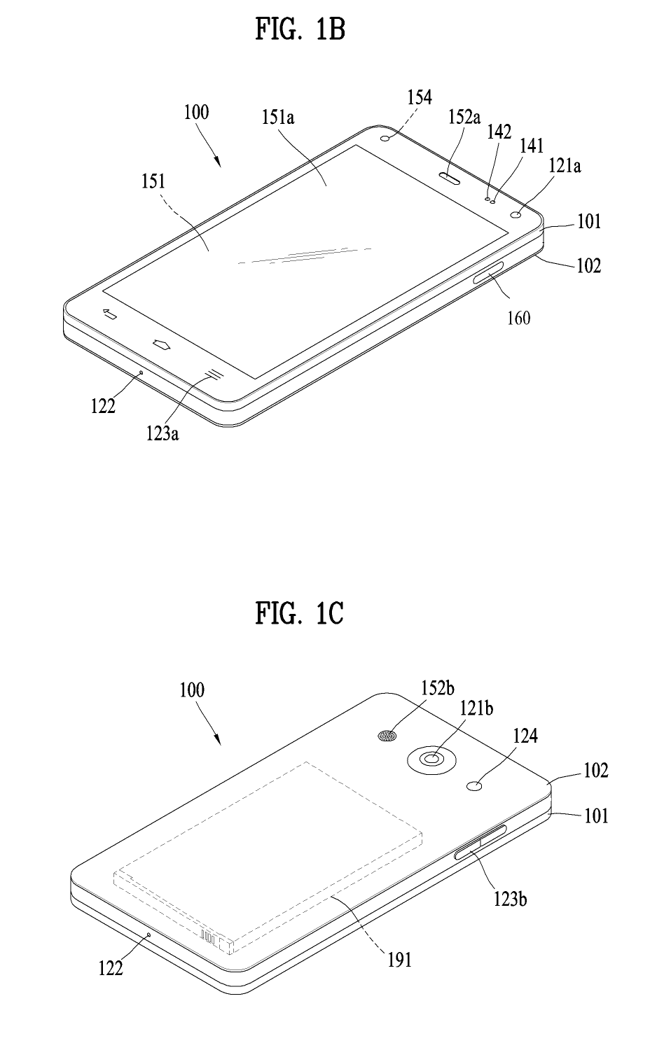

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components in The FIG. 1A is not a requirement, and that greater or fewer components may alternatively be implemented.

More specifically, the wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, the sensing unit 140 may alternatively or additionally include other types of sensors or devices, such as a proximity sensor 141 and an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output, or activating application programs stored in the memory 170.

To drive the application programs stored in the memory 170, the controller 180 may be implemented to control a predetermined number of the components mentioned above in reference with FIG. 1A. Moreover, the controller 180 may be implemented to combinedly operate two or more of the components provided in the mobile terminal 100 to drive the application programs.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Some or more of the components may be operated cooperatively to embody an operation, control or a control method of the mobile terminal in accordance with embodiments of the present disclosure. Also, the operation, control or control method of the mobile terminal may be realized on the mobile terminal by driving of one or more application problems stored in the memory 170.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

Here, the terminal body may be understood to refer to the concept of this bore a mobile terminal (100) to at least one of the aggregate.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover is shown covering the electronic components, and this cover may be detachably coupled to the rear case 102. Therefore, when the rear cover is detached from the rear case 102, the electronic components mounted to the rear case 102 are externally exposed.

An opening 102a to expose a part, such as the camera 121b or the audio output module 152b, located on the rear surface of the mobile terminal 100 may be provided on the rear case 102.

The cases 101, 102 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

However, if a metal is used, the metal influences functions of using electromagnetic waves, such as a wireless communication function, a wireless charging function, etc., and thus performance of the mobile terminal 100 may be degraded. Therefore, in order to secure performance of the mobile terminal 100, a non-conductive case formed of a non-conductive material, for example, a synthetic resin, may be partially arranged. Some of parts, into which the metal case is divided by the non-conductive case, may be used as radiators.

However, the non-conductive material which is partially used divides the appearance of the housing of the mobile terminal 100 and degrades design quality of the mobile terminal 100 and, thus, a design which minimizes an area of a non-conductive case formed of a non-conductive material is demanded.

Further, the mobile terminal 100 may include a waterproof part (not shown) preventing water penetration into the terminal body. For example, the waterproof part may include a waterproof member provided between the window 151a and the front case 101, between the front case 101 and the rear case 102 or between the rear case 102 and the rear cover so as to close an inner space formed therebetween when they are coupled to each other.

The mobile terminal 100 may include the display unit 151, the audio output module, the proximity sensor 141, the illuminance sensor 142, the optical output module 154, the camera 121, the user input unit 123, the microphone 122 and the interface unit 160.

It will be described for the mobile terminal as shown in FIGS. 1B and 1C. The display unit 151, the first audio output module 151a, the proximity sensor 141, an illumination sensor 142, the optical output module 154, the first camera 121a and the first manipulation unit 123a are arranged in front surface of the terminal body, the second manipulation unit 123b, the microphone 122 and interface unit 160 are arranged in side surface of the terminal body, and the second audio output modules 151b and the second camera 121b are arranged in rear surface of the terminal body.

It is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

A flash 124 is shown located adjacent to the second camera 121b. When an image of a subject is captured with the camera 121b, the flash 124 may illuminate the subject.

The second audio output module 152b can be located on the terminal body. The second audio output module 152b may implement stereophonic sound functions in conjunction with the first audio output module 152a, and may be also used for implementing a speaker phone mode for call communication

At least one antenna for wireless communication may be located on the terminal body. The antenna may be installed in the terminal body or formed by the case. For example, an antenna which configures a part of the broadcast receiving module 111 (see FIG. 1A) may be retractable into the terminal body. Alternatively, an antenna may be formed using a film attached to an inner surface of the rear case 102, or a case that includes a conductive material.

A power supply unit 190 for supplying power to the mobile terminal 100 may include a battery 191, which is mounted in the terminal body or detachably coupled to an outside of the terminal body.

The battery 191 may receive power via a power source cable connected to the interface unit 160. Also, the battery 191 can be recharged in a wireless manner using a wireless charger. Wireless charging may be implemented by magnetic induction or electromagnetic resonance.

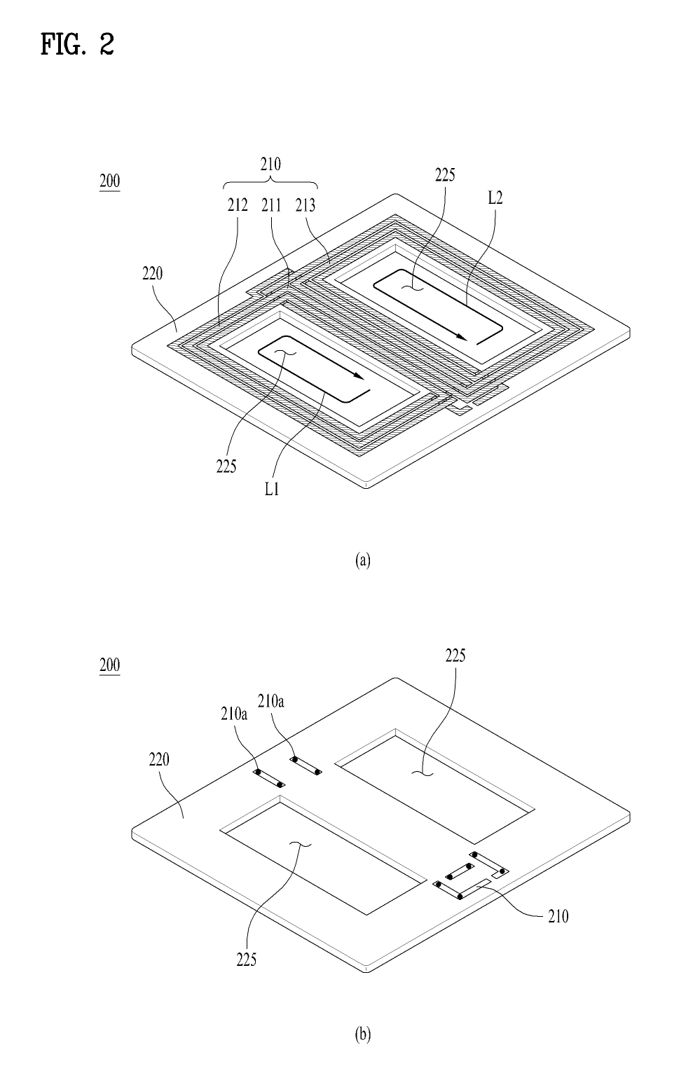

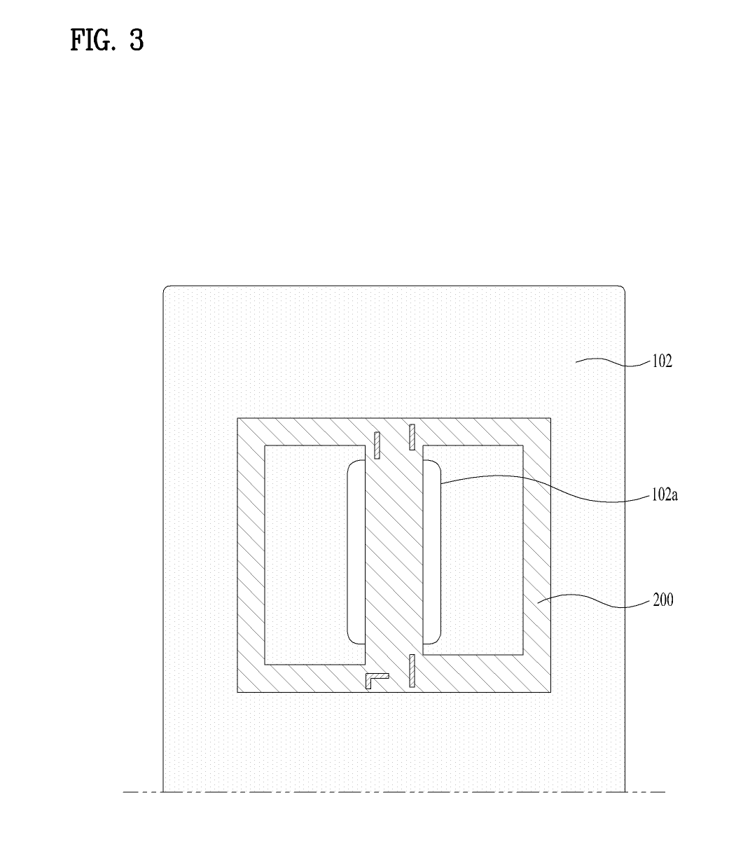

FIGS. 2(a) and 2(b) are views illustrating a coil antenna 200 of the mobile terminal 100 in accordance with the present invention and, in more detail, FIG. 2(a) illustrates one surface of the coil antenna 200 and FIG. 2(b) illustrates the other surface of the coil antenna 200. FIG. 3 is a view illustrating the inner surface (front surface) of the rear case 102 of the mobile terminal 100 in accordance with the present invention. One surface of the coil antenna 200 may be arranged to face in the rearward direction of the mobile terminal 100 and attached to the rear case 102, and the other surface of the coil antenna 200 may be attached to the rear case 102. In this embodiment, for convenience of description, the coil antenna 200, one surface of which is attached to the rear case 102, will be described.

The camera 121b, the audio output module 152b, the flash 124 or a rear button facing the rear surface of the mobile terminal 100 may be exposed to the outside through the opening 102a formed on the rear case 102. The rear case 102 in accordance with the present invention may include a metal. The rear case 102 formed of a metal provides a neat and firm appearance to the mobile terminal 100 and, thus, metals are preferred as a material of cases.

An antenna mounted in a mobile terminal is a conductive member which transmits and receives electromagnetic waves, and the antenna is influenced by electronic parts provided therearound and is thus arranged at the outermost region of the mobile terminal 100 so as to be stabilized. Therefore, a part of the case of the mobile terminal may be used as the antenna, or the antenna may be attached to the inner surface of the rear case 102.

Particularly, Near Field Communication (NFC) as short range communication may support wireless communication between the mobile terminal 100 and another mobile terminal 100 or between the mobile terminal 100 and a network where another mobile terminal 100 or an external server is located. Since NFC uses a signal of a low wavelength band of 13.56 MHz and performs wireless communication over an ultra-short distance of 10 cm or less, a coil antenna is used.

A coil antenna for short range communication does not propagate a signal in the air as in an antenna for wireless communication, but transmits a signal through a magnetic field by an electric field formed by current flowing in a coil. The coil antenna 200 may transmit and receive a signal when a counterpart antenna is located in a magnetic field formed by the coil antenna 200. The coil antenna 200 occupies a large area and is thus generally arranged so as to be attached to the inner surface of the rear case 102.

However, if the rear case 102 includes a metal, the rear case 102 obstructs an electromagnetic field formed by an NFC antenna and thus the NFC antenna cannot function properly. Conventionally, in order to secure performance of the NFC antenna, metal parts may be additionally removed. For example, one side of the opening 102a to expose the NFC antenna is opened. In this case, the opening 102a must have a long slit shape and such a shape hinders the design of the rear surface of the mobile terminal 100. Further, the NFC antenna must be arranged so as to be close to one side of the mobile terminal 100 and may thus cause interference with another antenna located at the upper end or the lower end of the mobile terminal 100.

However, in the present invention, performance of the NFC antenna may be secured using the opening 102a formed on the rear case 102 to expose other parts without hindrance of the exterior design of the mobile terminal 100. Further, the opening 102a may be located at the central portion of the rear surface of the mobile terminal 100 and thus minimize interference with other antennas.

As exemplarily shown in FIGS. 2(a) and 2(b), the coil antenna 200 in accordance with the present invention includes conductive strips 210 including first conductive strips 211 extending in a first direction, second conductive strips 212 located at one side of the first conductive strips 211 in a second direction perpendicular to the first direction, and third conductive strips 213 located at the other side of the first conductive strips 211 in the second direction, and the first to third conductive strips 211 to 213 are connected to form one coil. Therefore, two points of the first to third conductive strips 211 to 213 are connected to a feeder, and current flows along a connection shape of the conductive strips 210. For convenience of description, the first direction is referred to as the vertical direction and the second direction is referred to as the horizontal direction based on these figures. If the mobile terminal 100 is inclined at an angle of 90 degrees, the first direction may be the horizontal direction and the second direction may be the vertical direction.

The first conductive strips 211 are exposed through the opening 102a formed on the rear case 102. Here, as exemplarily shown in FIG. 3, a width of an area, where the first conductive strips 211 are formed, in the second direction is less than a width of the opening 102a in the second direction and, thus, all of a plurality of first conductive strips 2111 may be exposed in the second direction.

The first conductive strips 211 and the second conductive strips 212 form a first loop L1, and the first conductive strips 211 and the third conductive strips 213 form a second loop L2. As exemplarily shown in FIGS. 2(a) and 2(b), since the first to third conductive strips 211 and 213 are provided in plural and the first loop L1 and the second loop L2 share the first conductive strips 211, the number n1 of the first conductive strips 211 may correspond to the sum n2+n3 of the number n2 of the second conductive strips 212 and the number n3 of the third conductive strips 213.

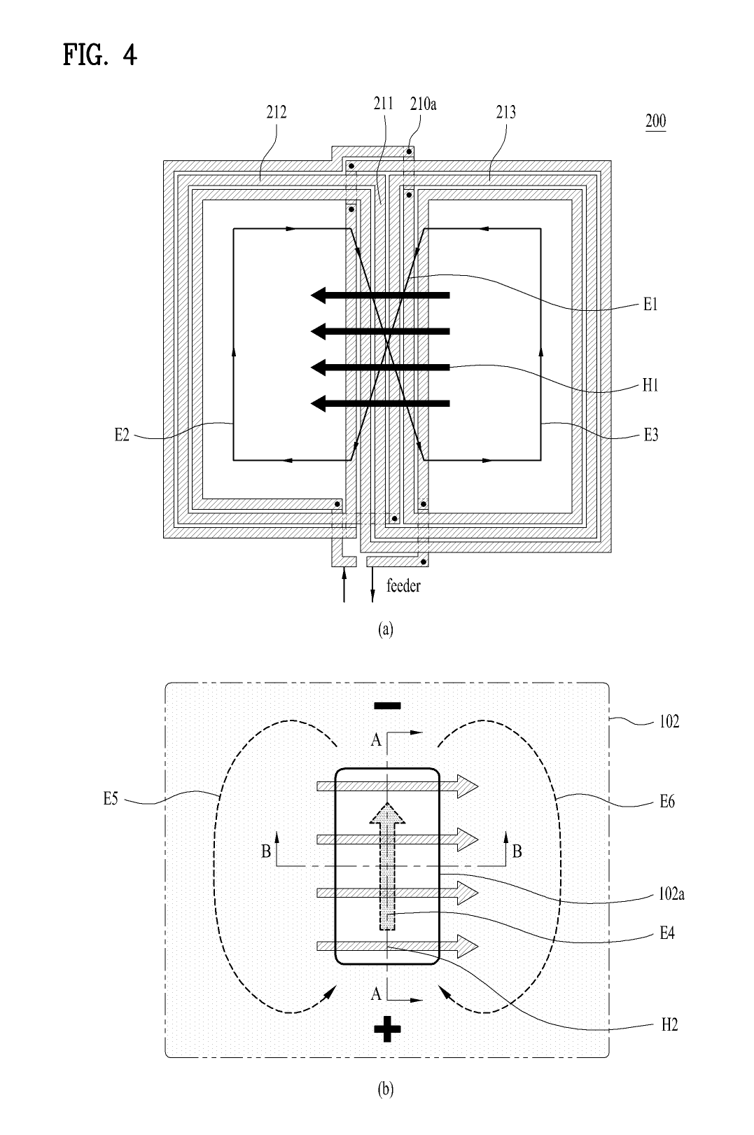

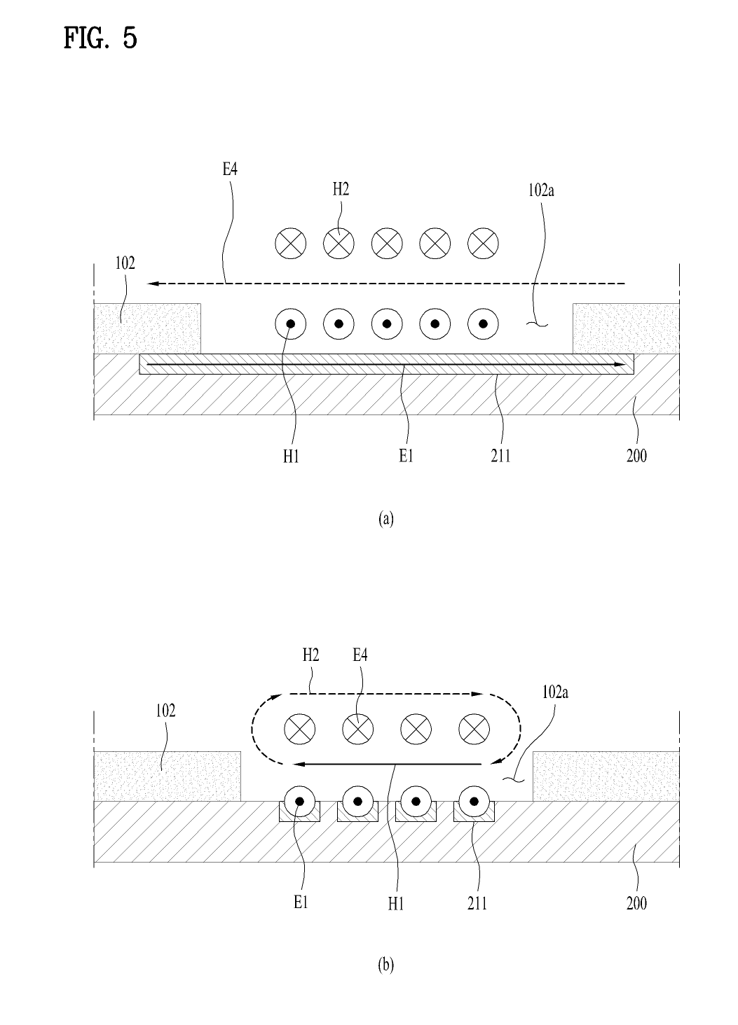

FIGS. 4(a) and 4(b) and FIGS. 5(a) and 5(b) are views illustrating electric fields (E-fields) and magnetic fields (H-fields) formed in the coil antenna 200 and on the rear case 102 of the mobile terminal 100 in accordance with the present invention. FIG. 4(a) illustrates electric fields and a magnetic field in the coil antenna 200, and FIG. 4(b) illustrates electric fields and a magnetic field on the rear case 102.

FIG. 4(a) illustrates the rear surface of the coil antenna 200, one end of each of the first conductive strips 211 is connected to the second conductive strip 212 and the other end of each of the first conductive strips 211 is connected to the third conductive strip 213 and, thus, the first conductive strips 211, the second conductive strips 212 and the third conductive strips 213 are connected in a ∞ shape. That is, power applied to the coil antenna 200 flows so as to reciprocate between the first loop L1 and the second loop L2, and an electric field of a ∞ shape is formed along current flow.

In order to allow the first to third conductive strips 211 to 213 to form continuous conductive strips without overlap between the continuous conductive strips, both surfaces of an insulating substrate 220 may be used. That is, the first to third conductive strips 211 to 213 may be divisionally formed on one surface and the other surface of the insulating substrate 220 and the conductive strips 210 formed on both surfaces of the insulating substrate 220 may be connected through via holes 210a formed through the insulating substrate 220.

A current flow E1 along the first conductive strips 211 is formed in the downward direction in both the first loop L1 and the second loop L2, a current flow E2 along the second conductive strips 212 is formed in the clockwise direction, and a current flow E3 along the third conductive strips 213 is formed in the counterclockwise direction. If the current flow along the first conductive strips 211 is formed in the upward direction, the current flows along the second conductive strips 212 and the third conductive strips 213 are formed in opposite directions.

Since the current flow E1 along the first conductive strips 211 is formed in the downward direction, a magnetic field (H-field) H1 is formed in the leftward direction from the right side of the first conductive strips 211 by the electric field E1 of the first conductive strips 211.

FIG. 4(b) illustrates the rear surface of the rear case 102, and the rear case 102 arranged to cover the coil antenna 200 includes a metal. Since an electric field on the surface of a conductive member is 0 (a boundary condition of a conductor surface), current flows in a direction, opposite to the direction of the electric field formed by the coil antenna 200 located on the front surface of the rear case 102, at the outside (on the rear surface) of the rear case 102 formed of a metal.

That is, in FIG. 4(b), an electric field E5 in the counterclockwise direction opposite to the current flow E2 of the first loop L1 of the coil antenna 200 is formed at the left side of the rear case 102, and an electric field E6 in the clockwise direction opposite to the current flow E3 of the second loop L2 of the coil antenna 200 is formed at the right side of the rear case 102.

The electric fields E5 and E6 formed on the surface of the rear case 102 cause a potential difference between both ends of the opening 102a in the first direction. The lower end of the opening 102a has positive (+) polarity and the upper end of the opening 102a has negative (−) polarity and, thus, an electric field E4 is formed in a direction from positive (+) polarity to negative (−) polarity. A magnetic field H2 is formed in the rightward direction on the rear surface of the rear case 102 by the electric field E4 formed in the upward direction, as exemplarily shown in FIG. 4(b).

FIG. 5(a) is a cross-section taken along line A-A of FIG. 4(b) (taken in the first direction around the opening 102a), illustrating the electric fields and the magnetic fields, and FIG. 5(b) is a cross-section taken along line B-B of FIG. 4(b) (taken in the second direction around the opening 102a), illustrating the electric fields and the magnetic fields.

The left side of FIG. 5(a) corresponds to the upper side of FIG. 4(a) or 4(b) and the right side of FIG. 5(a) corresponds to the lower side of FIG. 4(a) or 4(b). The electric field E1 in the downward direction is formed along the first conductive strips 211, and the electric field E4 in the upward direction is formed on the surface (rear surface) of the rear case 102. The magnetic field H1 formed on the surface (rear surface) of the coil antenna 200 by the electric fields of the coil antenna 200 is formed in a direction of coming out of the figure, and the magnetic field H2 formed on the surface of the rear case 102 is formed in a direction of going into the figure.

In FIG. 5(b), the electric field E1 formed along the first conductive strips 211 is formed in a direction of coming out of the figure, and the electric field E4 formed on the surface of the rear case 102 is formed in a direction of going into the figure. The magnetic fields H1 and H2 are formed in opposite directions due to the electric fields E1 and E4 and thus form a loop, as exemplarily shown in FIG. 5(b).

A size of the opening 102a may be greater than the width of the area, where the first conductive strips 211 are formed, in the second direction. If the width of the opening 102a in the second direction is less than the width of the area, where the first conductive strips 211 are formed, current flowing along the first conductive strips 211 forms an electric field offsetting the electric fields E5 and E6 flowing on the rear case 102 and, thus, a potential difference between both ends of the opening 102a in the first direction is reduced. Then, an intensity of the electric field E4 is decreased and thus an intensity of the magnetic field H2 is decreased.

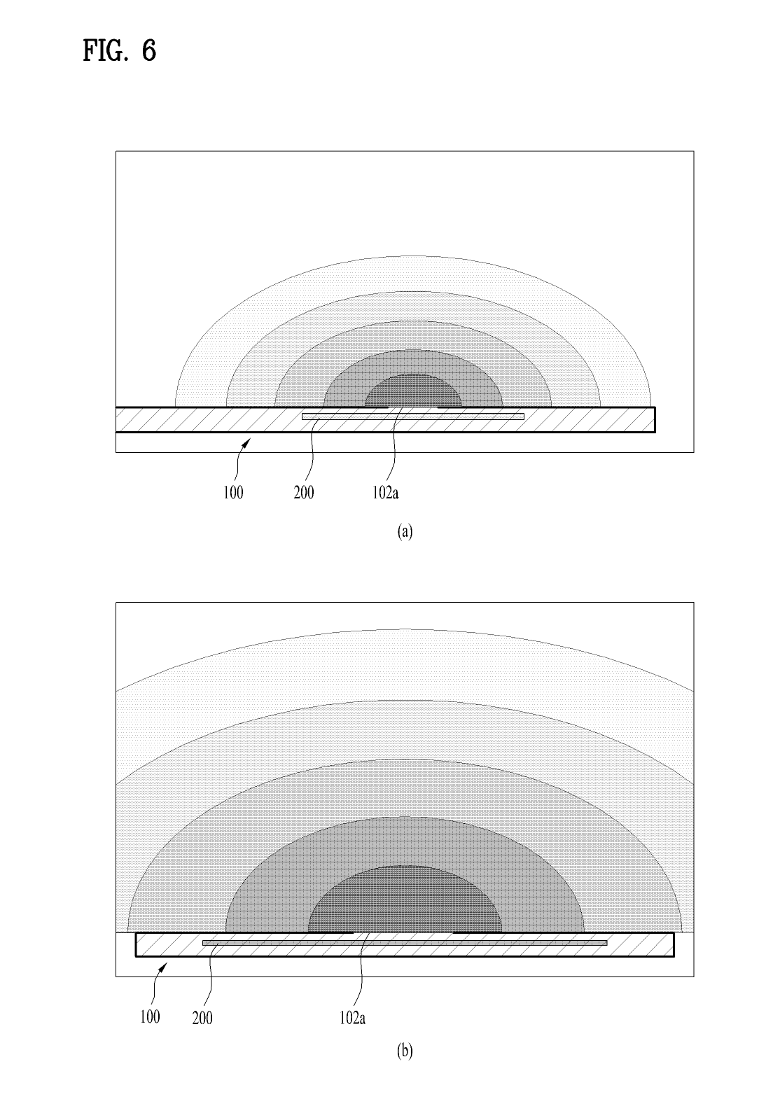

FIGS. 6(a) and 6(b) are views illustrating a magnetic field formed on the mobile terminal 100 in accordance with the present invention. FIG. 6(a) is a cross-sectional view of the mobile terminal 100 taken in the first direction, as seen from the second direction, and FIG. 6(b) is a cross-sectional view of the mobile terminal 100 taken in the second direction, as seen from the first direction. Although the rear case 102 is formed of a metal, the magnetic field is formed on the surface of the rear case 102 by the coil antenna 200 located within the rear case 102 and, thus, the coil antenna 200 may perform wireless communication.

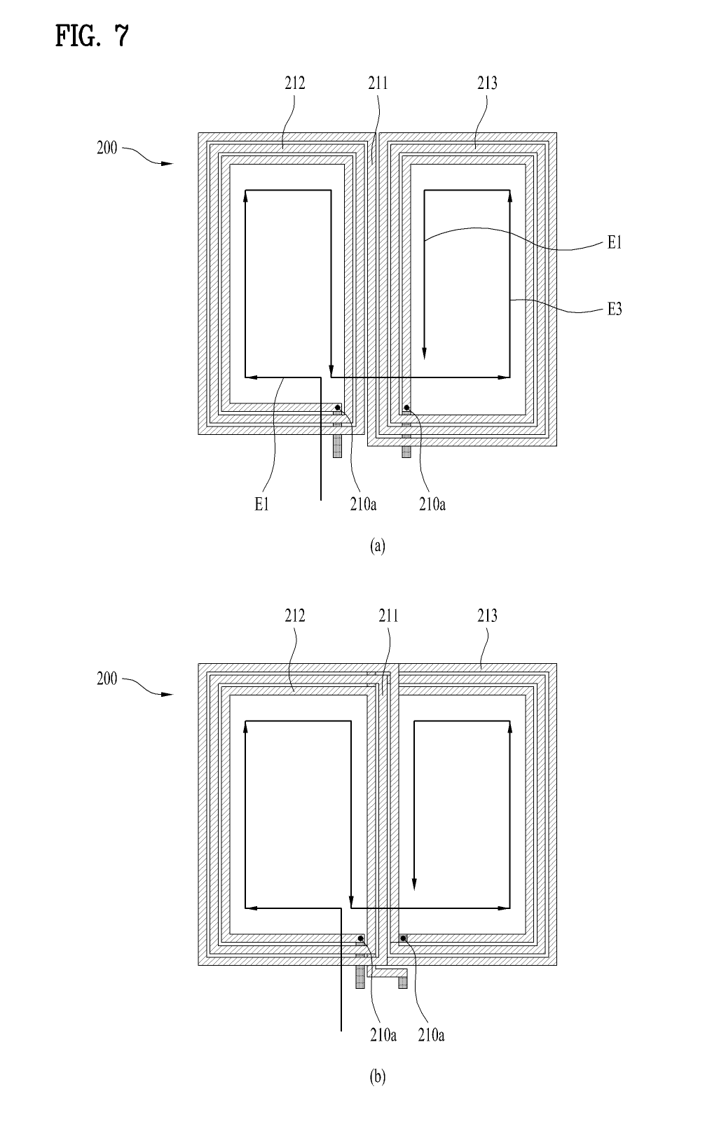

FIGS. 7(a) and 7(b) are views illustrating coil antennas 200 of the mobile terminal 100 in accordance with other embodiments of the present invention. The conductive strips of the coil antenna 200 may be formed in a ∞ shape so as to reciprocate between both sides of the coil antenna 200, without being limited thereto, as exemplarily shown in FIGS. 4(a) and 4(b), but the coil antenna 200 may have any structure in which current flows along second conductive strips 212 and third conductive strips 213 in opposite directions so that current may flow along first conductive strips 211 in a designated direction.

As exemplarily shown in FIG. 7(a), both ends of some of first conductive strips 211 are connected to second conductive strips 212 and form a spiral-shaped first loop L1, and both ends of the remainder of the first conductive strips 211 are connected to third conductive strips 213 and form a spiral-shaped second loop L2. Current flows spirally along the first loop L1 in the clockwise direction and then flows along the second loop L2 in the counterclockwise direction.

As exemplarily shown in FIG. 7(b), some of first conductive strips 211 are formed on the other surface of the insulating substrate 200 so as to decrease a width of an area, where the first conductive strips 211 are formed, in the second direction. For example, the first conductive strips 211 belonging to a first loop L1 may be formed on one surface of the insulating substrate 220, and the first conductive strips 211 belonging to a second loop L2 may be formed on the other surface of the insulating substrate 220.

If a plurality of parts is exposed through the opening 102a, the first wirings 211 may be arranged between the parts. However, if an interval between the parts is narrow, the first wirings 211 may not be arranged between the parts. Therefore, as exemplarily shown in FIG. 7(b), when the width of the area, where the first conductive strips 211 are formed, is decreased by arranging the first conductive strips 211 so as to overlap each other, the first conductive strips 211 may be arranged in a narrow space.

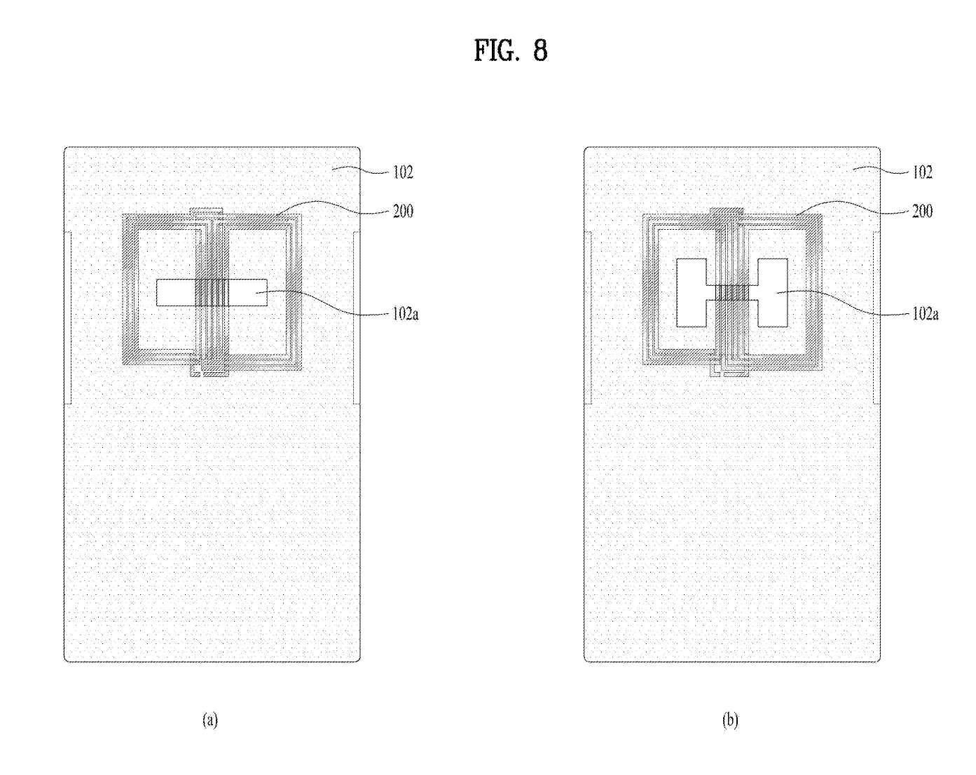

FIGS. 8(a) and 8(b) are views illustrating arrangements of the coil antenna 200 and the opening 102a of the mobile terminal 100 in accordance with the present invention. Not only if the opening 102a extending in the vertical direction is formed, as exemplarily shown in FIG. 3, but also if the opening 102a extending in the horizontal direction is formed, as exemplarily shown in FIG. 8(a) or 8(b), the dual camera 121b or the flash 124 may be arranged in the lateral direction. Since all the first conductive strips 211 are exposed through the opening 102a in the second direction, formation of the opening 102a in the horizontal direction may be favorable.

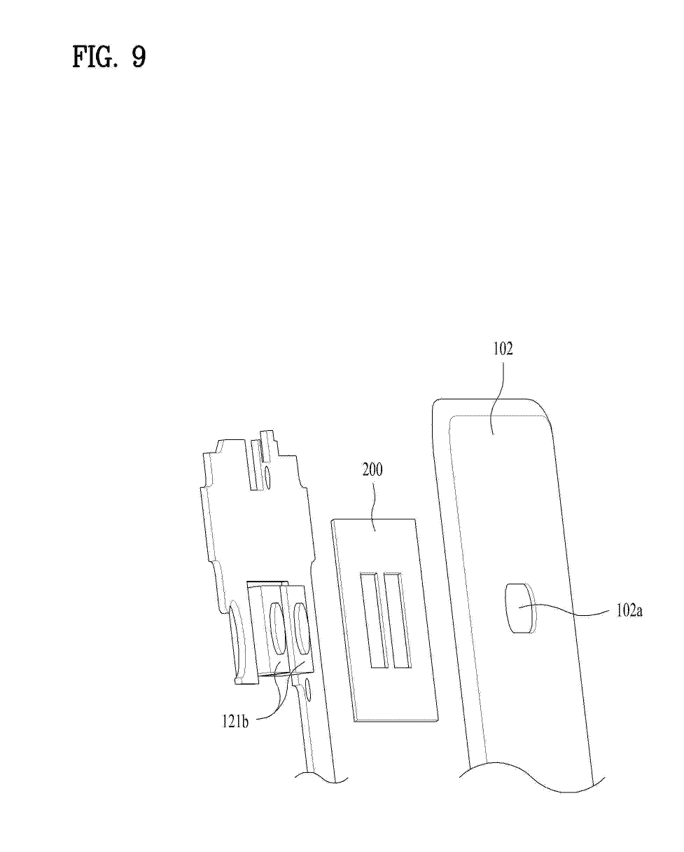

FIG. 9 is a view illustrating arrangement of the coil antenna 200 and cameras 121b of the mobile terminal 100 in accordance with the present invention. As exemplarily shown in FIG. 9, in order to expose some parts, such as the cameras 121b, through the opening 102a, regions of the insulating substrate 220 of the coil antenna 200 corresponding to the parts must be omitted. Regions 225 of the insulating substrate 220 surrounded by the first loop L1 and the second loop L2 are provided with no conductive strips and may thus be omitted, as exemplarily shown in FIG. 2.

The first conductive strips 211 may be arranged between a pair of cameras 121b and, thus, the mobile terminal 100 including the rear case 102 formed of a metal may secure performance of the coil antenna (NFC antenna), which is a designated reference or more, using the conventional opening 102a of the rear case 102 formed to expose a dual camera.

As is apparent from the above description, a mobile terminal in accordance with the present invention may prevent degradation of performance of a coil antenna if a rear case includes a metal.

Particularly, an opening to expose other parts, such as a camera, a rear button, etc., may be used as is and, thus, antenna performance may be secured without hindrance of exterior design of the mobile terminal.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A mobile terminal comprising:
a main body comprising a rear case comprising a metal part;
an opening formed through the rear case;
a coil antenna located within the main body and comprising a plurality of conductive strips; and
a feeder configured to apply power to the coil antenna,
wherein the plurality of conductive strips comprises:
first conductive strips extending in a first direction, at least some of the first conductive strips overlapping the opening;
second conductive strips located at one side of the first conductive strips and extending in a second direction that is perpendicular to the first direction, wherein the second conductive strips are connected to the first conductive strips to form a first loop; and
third conductive strips located at another side of the first conductive strips and extending in the second direction, wherein the third conductive strips are connected to the first conductive strips to form a second loop,
wherein the first conductive strips, the second conductive strips, and the third conductive strips are connected to form a continuous coil.

2. The mobile terminal according to claim 1, wherein current flows along the first conductive strips in the first direction, flows along the second conductive strips in a clockwise direction, and flows along the third conductive strips in a counterclockwise direction when the power is applied to the coil antenna.

3. The mobile terminal according to claim 1, wherein a width of the opening in the second direction is greater than a width of an area in the second direction, the area being where the first conductive strips are formed along the opening.

4. The mobile terminal according to claim 1, wherein the coil antenna further comprises:
an insulating substrate provided with a first surface and a second surface, on which the plurality of conductive strips are divisionally arranged; and
via holes formed through the insulating substrate and connecting the plurality of conductive strips formed on the first and second surfaces of the insulating substrate.

5. The mobile terminal according to claim 4, wherein the first conductive strips are divisionally arranged on both the first and second surfaces of the insulating substrate so as to overlap each other.

6. The mobile terminal according to claim 4, wherein the insulating substrate comprises open areas formed at regions surrounded by the first loop and the second loop.

7. The mobile terminal according to claim 1, wherein a number of the first conductive strips is a sum of a number of the second conductive strips and a number of the third conductive strips.

8. The mobile terminal according to claim 7, wherein one end of each of the first conductive strips is connected to the second conductive strips and another end of each of the first conductive strips is connected to the third conductive strips such that the first conductive strips, the second conductive strips, and the third conductive strips are connected in an 8 shape.

9. The mobile terminal according to claim 7, wherein the first conductive strips comprise:
a first group of conductive strips provided with both ends connected to the second conductive strips to form the first loop that is spiral-shaped; and
a second group of conductive strips provided with both ends connected to the third conductive strips to form the second loop that is spiral-shaped.

10. The mobile terminal according to claim 1, wherein the opening is located at a center of the rear case.

11. The mobile terminal according to claim 1, wherein the opening is surrounded by the metal part of the rear case.

12. The mobile terminal according to claim 1, further comprising a rear button or a camera arranged on a rear surface of the main body and exposed from the rear surface through the opening.

13. The mobile terminal according to claim 1, wherein the coil antenna is coupled to an inner surface of the rear case.

14. The mobile terminal according to claim 1, further comprising a controller configured to control the feeder so as to perform Near Field Communication (NFC) wireless communication via the coil antenna.

15. A mobile terminal comprising:
a main body comprising a rear case comprising a metal;
an opening formed through the rear case;
a pair of cameras exposed from a rear surface of the main body through the opening;
a coil antenna located within the main body and comprising a plurality of conductive strips; and
a feeder configured to apply power to the coil antenna,
wherein the plurality of conductive strips comprises:
first conductive strips extending in a first direction and located between the pair of cameras, at least some of the first conductive strips overlapping the opening;
second conductive strips located at one side of the first conductive strips and extending in a second direction that is perpendicular to the first direction, wherein the second conductive strips are formed in a C shape; and
third conductive strips located at the other side of the first conductive strips and extending in the second direction, wherein the third conductive strips are formed in a C shape,
wherein the first conductive strips, the second conductive strips, and the third conductive strips are connected to form a single 8-shaped coil.

16. The mobile terminal according to claim 15, wherein the coil antenna further comprises:
an insulating substrate provided with a first surface and a second surface on which the plurality of conductive strips are divisionally arranged; and
via holes formed through the insulating substrate and connecting the plurality of conductive strips formed on both the first and second surfaces of the insulating substrate,
wherein the insulating substrate comprises open areas formed in regions surrounded by the C-shaped second conductive strips and the C-shaped third conductive strips, the pair of cameras being located in the open areas.
